(19) United States
(12) Patent Application Publication
(10) Pub. No.: US 2025/0203653 A1
(43) Pub. Date: Jun. 19, 2025

(54) METHODS FOR EFFICIENT SIDELINK SCHEDULING IN UNLICENSED SPECTRUM

(71) Applicant: INTERDIGITAL PATENT HOLDINGS, INC., Wilmington, DE (US)

(72) Inventors: Aata El Hamss, Laval (CA); Tao Deng, New York, NY (US); Tuong Hoang, Montreal (CA); Patrick Tooher, Montreal (CA); Moon IL Lee, Melville, NY (US); Paul Marinier, Brossard (CA)

(73) Assignee: INTERDIGITAL PATENT HOLDINGS, INC., Wilmington, DE (US)

(21) Appl. No.: 18/851,836

(22) PCT Filed: Apr. 26, 2023
(86) PCT No.: PCT/US2023/019932

§ 371 Date: Sep. 27, 2024

Related U.S. Application Data
(60) Provisional application No. 63/334,977, filed on Apr. 26, 2022.
(60) Provisional application No. 63/445,516, filed on Feb. 14, 2023.

(51) Int. Cl. H04W 74/0808; H04W 72/21; H04W 72/232; H04W 92/18

(52) U.S. Cl. CPC H04W 74/0808; H04W 72/21; H04W 72/232; H04W 92/18

(57) ABSTRACT

A wireless transmit/receive unit (WTRU) may receive downlink control information (DCI) scheduling a sidelink (SL) grant that indicates a time window to initiate a channel occupancy time (COT). The WTRU may perform listen-before-talk (LBT) to access an SL unlicensed channel in an unlicensed band within the indicated time window to initiate the COT. After a successful channel access outcome of the performed LBT, the WTRU may transmit uplink control information (UCI) to a base station. The UCI may indicate the successful channel access outcome and a COT starting time within the indicated time window to initiate the COT. Also, the UCI may further indicate an intended number of transmissions by the WTRU in the COT. Moreover, the UCI may further indicate reserved sub-channels, reserved interlaces, or both, within the COT. Additionally, based on a buffer status and the COT starting time, the WTRU may determine whether to share the COT.

### CROSS-REFERENCE TO RELATED APPLICATIONS

This application claims the benefit of U.S. Provisional Application No. 63/334,977, filed Apr. 26, 2022, and U.S. Provisional Application No. 63/445,516, filed Feb. 14, 2023, the contents of which are incorporated herein by reference.

### BACKGROUND

In unlicensed bands, a channel access procedure may be required prior to transmit to ensure fair sharing of the unlicensed spectrum between different radio access technologies. Channel access may use a listen-before-talk (LBT) procedure. If there is LBT failure, the scheduled grant may not be used. To avoid performing multiple LBTs, a transmitter may initiate a channel occupancy time (COT) and keep it for a relatively long duration. In New Radio (NR) in unlicensed spectrum, the gNode B (gNB) may be aware of the success or failure of the LBT at the wireless transmit/receive unit (WTRU) side, since the transmission is intended for the gNB.

In Mode 1 sidelink, the gNB may be responsible for scheduling in sidelink channels. The WTRU may request a sidelink grant from the gNB and receive downlink control information (DCI) that schedules sidelink resources. The WTRU may report sidelink hybrid automatic repeat request (HARQ) acknowledgement (ACK) feedback to the gNB and accept additional resources for sidelink retransmission when it reports negative ACK (NACK).

The WTRU may fail to access the channel to transmit the scheduled resources for sidelink unlicensed channel. For multi-slot scheduling, one LBT failure may impact multiple scheduled slots and lead to inefficient resource utilization. The gNB may not be able to determine if the WTRU was able to access the channel or not, since the sidelink transmission is not intended for the gNB.

### SUMMARY

Methods and apparatus for efficiently scheduling sidelink (SL) transmission and associated uplink feedback for Mode 1 SL in unlicensed spectrum are disclosed herein. In an example, a first wireless transmit/receive unit (WTRU) may receive downlink control information (DCI) from a base station scheduling an SL grant that indicates a time window to initiate a channel occupancy time (COT). The first WTRU may perform listen-before-talk (LBT) to access an SL unlicensed channel in an unlicensed band within the indicated time window to initiate the COT. After a successful channel access outcome of the performed LBT, the first WTRU may transmit uplink control information (UCI) to the base station. The UCI may indicate or may report the successful channel access outcome and a COT starting time within the indicated time window to initiate the COT.

In another example, the UCI may further indicate an intended number of transmissions by the first WTRU in the COT. Also, the UCI may further indicate one or more reserved sub-channels within the COT. In addition, the UCI may further indicate one or more reserved interlaces within the COT. In a further example, based on a buffer status and the COT starting time, the first WTRU may determine whether to share the COT. Based on a determination to share the COT, the first WTRU may provide a COT sharing suggestion to the base station. Further, the first WTRU may receive a COT sharing confirmation validating the COT sharing suggestion provided by the first WTRU.

The first WTRU may also initiate the COT. Also, the COT may be initiated at the COT starting time and may last for a COT duration. Moreover, the first WTRU may occupy the SL unlicensed channel during the COT. Further, the first WTRU may monitor physical sidelink feedback channel (PSFCH) transmissions of one or more second WTRUs sharing the COT initiated by the first WTRU. Also, the WTRU may indicate or may report, to the base station, SL hybrid automatic repeat request (HARQ)-acknowledgement (ACK) feedback received from the one or more PSFCH transmissions of the one or more second WTRUs sharing the COT initiated by the first WTRU. In an example, the first WTRU may be a transmitter (Tx) WTRU.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating an example of a WTRU indicated with a resource block (RB) set and time window to initiate a channel occupancy time (COT) in a sidelink unlicensed channel;

FIG. 3 is a diagram illustrating an example of a WTRU reporting the COT starting time as an offset;

FIG. 4 is a diagram illustrating an example of a transmitter (Tx) WTRU reporting on its initiated COT to a base station;

FIG. 5 is a flowchart diagram illustrating an example of a WTRU reporting on its initiated COT to a base station; and

FIG. 6 is a diagram illustrating a Tx WTRU reporting a delayed sidelink hybrid automatic repeat request (HARQ) acknowledgement (ACK) to a base station.

### DETAILED DESCRIPTION

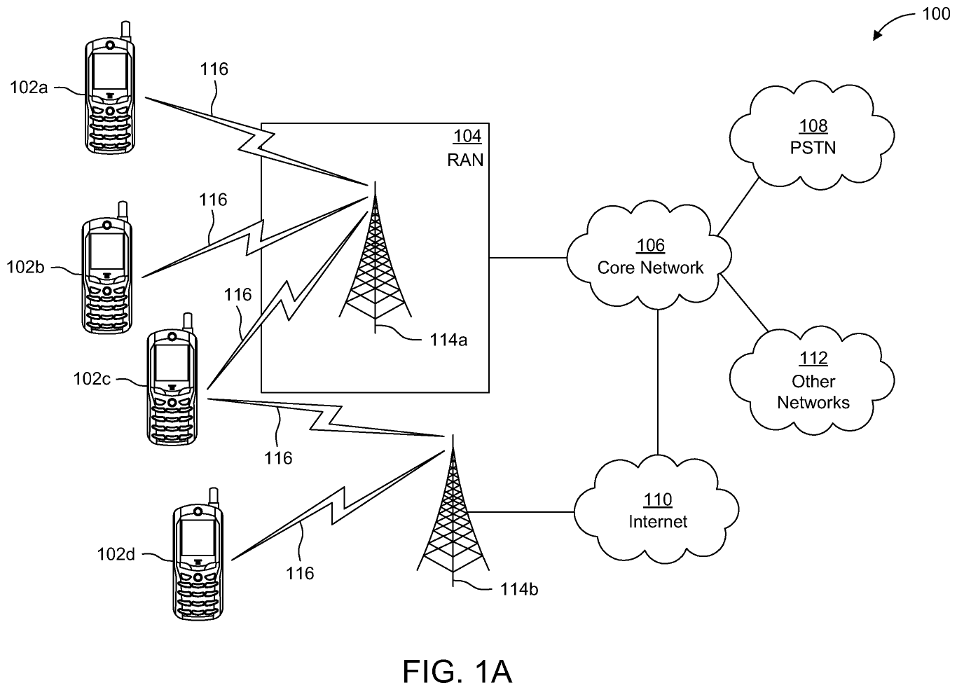

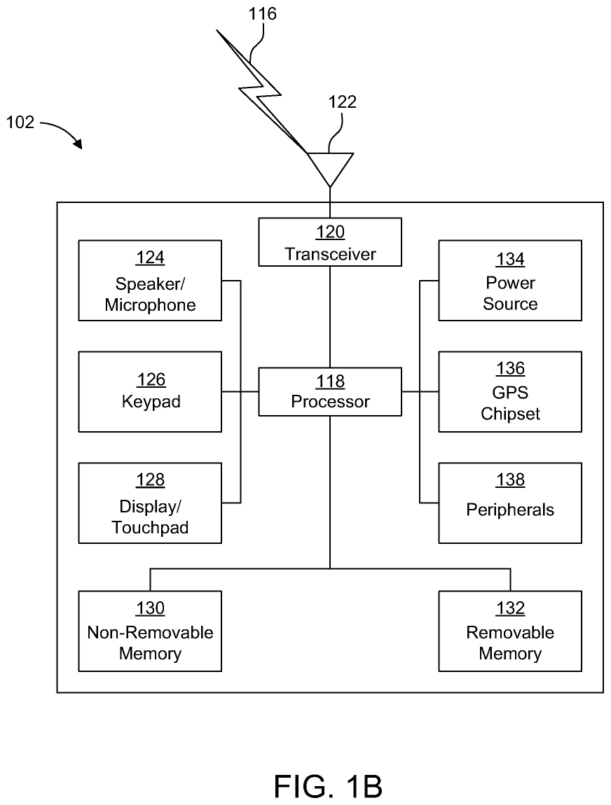

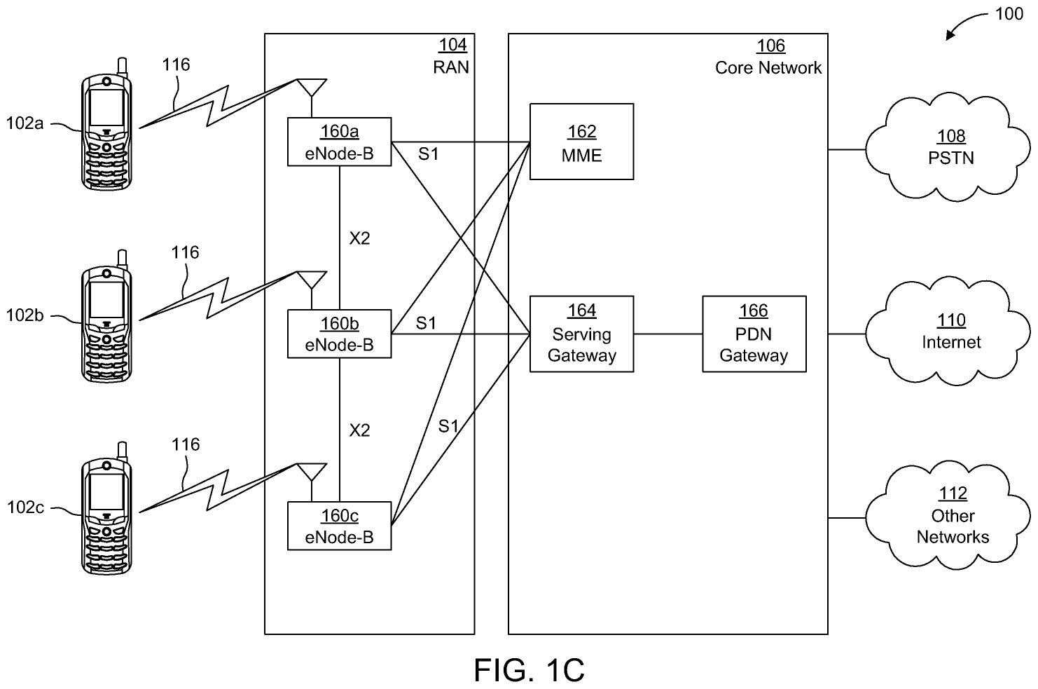

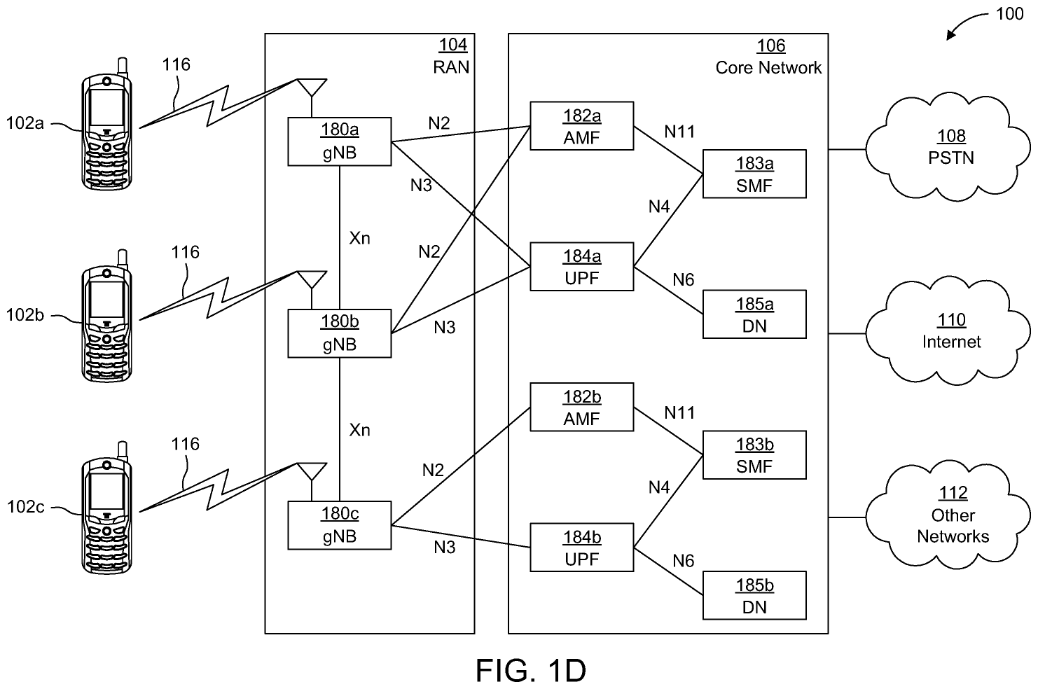

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. Byway of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the ON 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to alocal DN 185a, 185b through the UPF 184a, 184b via the N3 interface to the UPF 184a, 184b and an N6 interface between the UPF 184a, 184b and the DN 185a, 185b.

In view of FIGS. 1A-ID, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Methods for efficiently scheduling sidelink transmission and associated uplink feedback for mode 1 sidelink communications in unlicensed spectrum to minimize ambiguity between the gNB and the WTRU due to listen-before-talk (LBT) uncertainty are desirable. Embodiments and examples provided herein include solutions to minimize this ambiguity and improve sidelink communications efficiency.

In some embodiments, a WTRU may be configured with a resource block (RB) set within a resource pool and/or transmission window to initiate a channel occupancy time (COT) in a sidelink unlicensed channel. The WTRU may then report the LBT status and its initiated COT structure upon acquiring the channel. After the sidelink transmissions, the WTRU may transmit the sidelink hybrid automatic repeat request (HARQ) feedback of other WTRUs transmitted on its own COT. The WTRU may request a sidelink unlicensed grant from the gNB and indicate a preference to initiate its own COT. The WTRU may receive downlink control information (DCI) indicating the RB set/resource pool/transmission window and a maximum COT duration to initiate in sidelink unlicensed channel. The WTRU may perform a success LBT and initiate a COT in slot n. The WTRU may report the initiated COT characteristics to the gNB using a physical uplink control channel (PUCCH) transmission or a new uplink control information (UCI) type piggybacked in a physical downlink shared channel (PUSCH) transmission. The WTRU may transmit a PUSCH transmission, a PUCCH transmission, or both, in slot n+offset_1, where offset_1 is configured by the gNB and can be set to 0 based on the WTRU capability. The WTRU may indicate its intended number transmission(s) in the COT and the interlaces reserved for its own transmission(s). The WTRU may indicate a COT sharing suggestion to the gNB. The sharing suggestion may include the set of slots and interlace to be shared with other WTRUs.

The WTRU may receive sharing information/confirmation of its own COT by the gNB using group common DCI. Based on the COT sharing information, the WTRU may monitor the physical sidelink feedback channels (PSFCHs) of other WTRUs within the WTRU's COT. The WTRU may determine PSFCH occasions to monitor based on the shared physical sidelink shared channel (PSSCH) transmission occasions for other WTRUs. The WTRU may report to the gNB the sidelink HARQ feedback corresponding to its transmission as well as sidelink HARQ feedback transmitted by other WTRUs within the shared COT using PUCCH resources, PUSCH resources, or both.

In some examples, the transmitter (Tx) WTRU may report to the gNB a delayed HARQ-acknowledge (ACK) value upon failing to share its COT with a receiver (Rx) WTRU to transmit sidelink HARQ-ACK feedback. The WTRU may monitor DCI to indicate whether an additional PUCCH may be allocated for sidelink unlicensed HARQ transmission or may wait for one-shot HARQ-ACK to be triggered.

The Tx WTRU may be configured from the gNB with single or multiple slots for sidelink unlicensed transmissions. The Tx WTRU may transmit on the scheduled grant(s) upon successful LBT. Based on its intended transmission(s), for example, buffer, at the start of the transmission, the WTRU may determine whether it will share the COT or not with the Rx WTRU. If the Tx WTRU is not sharing its COT with the Rx WTRU to transmit sidelink HARQ-ACK feedback, the WTRU may report a delayed HARQ-ACK feedback value to the gNB. The delayed HARQ-ACK feedback can carry an estimated time for sidelink HARQ transmission based on: the expected future COT sharing by the Tx WTRU in subsequent slots, and/or the available sidelink unlicensed grants in the Tx WTRU. The Tx WTRU may flush the HARQ-ACK buffer corresponding to sidelink unlicensed transmission when the packet delay budget (PDB) is expired. The WTRU may indicate an ACK value to the gNB upon the PDB expiring.

Upon reporting a delayed HARQ feedback, the Tx WTRU may receive DCI that may indicate: a new PUCCH resource to acknowledge the sidelink HARQ-ACK transmission in later occasion, and/or wait for one-shot HARQ-ACK codebook to trigger the HARQ feedback for group of sidelink unlicensed grants.

Vehicle-to-everything (V2X) communication supports direct communication between vehicular WTRUs using sidelink channels. Vehicles platooning enables vehicles traveling together to dynamically form a group. All of the vehicles in the platoon may receive periodic data from the leading vehicle to carry on platoon operations. This information allows the distance between vehicles to become extremely small. In an example, the gap distance translated to time can be very low, such as sub-second. Platooning applications may allow the vehicles following to be autonomously driven.

Extended sensors enable the exchange of raw or processed data gathered through local sensors or live video data among vehicles, roadside units (RSUs), devices of pedestrians and V2X application servers. The vehicles may enhance the perception of their environment beyond what their own sensors can detect and have a more holistic view of the local situation.

Advanced driving enables semi-automated or fully automated driving. Longer inter-vehicle distance is assumed. Each vehicle and/or RSU shares data obtained from its local sensors with vehicles in proximity, thus allowing vehicles to coordinate their trajectories or maneuvers. In addition, each vehicle shares its driving intention with vehicles in proximity. The benefits of this use case group are safer traveling, collision avoidance, and improved traffic efficiency.

Remote driving enables a remote driver or a V2X application to operate a remote vehicle for those passengers who cannot drive themselves or a remote vehicle located in dangerous environments. For a case where variation is limited and routes are predictable, such as public transportation, driving based on cloud computing can be used. In addition, access to cloud-based back-end service platform can be considered for this use case group.

Resource allocation is used in NR V2X. There are two modes defined for V2X scheduling in NR V2X: Mode 1 and Mode 2. With Mode 1, the gNB is responsible for scheduling sidelink grants to be used in sidelink channels. There are two ways for a gNB to assign grants to V2X WTRUs, either by using dynamic grant which is scheduled by DCI or using is configured grants. Two types of configured grants are supported: Type 1 and Type 2. Type 1 configured grant is semi-statically configured using radio resource control (RRC) and the V2X WTRU can use it when it is needed. In Type 2 configured grant, some of the configuration is signaled using RRC, but the grant itself is activated using DCI.

With Mode 2, the WTRU autonomously selects sidelink resource from a preconfigured resource pool using sensing methods to minimize the collision with other V2X WTRUs.

In Mode 1, the gNB is responsible for allocating sidelink resources for V2X WTRUs for initial transmission and retransmissions. The gNB may need to know the outcome of sidelink transmissions, for example, whether it was a successful transmission or not, to allocate new resources if needed. A V2X WTRU operating in Mode 1 may report the sidelink HARQ-ACK for a scheduled transmission to the gNB, the network or both, using PUCCH resource(s). The gNB assigns a PUCCH resource to the WTRU using the DCI scheduling a sidelink grant.

Unlicensed spectrum provides large bandwidth at no cost. As operations in unlicensed spectrum reduces the cost for service providers, it is expected to have more WTRUs operating in unlicensed spectrum.

In unlicensed bands, a channel access procedure is required prior to transmit to ensure fair sharing of the unlicensed spectrum between different radio access technologies. Channel access uses an LBT procedure. The LBT procedure may be defined as a mechanism by which an equipment applies a clear channel assessment (CCA) check before using the channel. The CCA utilizes at least energy detection to determine the presence or absence of other signals on a channel to determine if a channel is occupied or clear, respectively. For some LBT types, fixed sensing duration equal to 16 or 25 μs is used, and for other types, a random number N corresponding to the number of clear idle slots is used. There are four channel access types, which may be referred to as LBT types, defined.

In Type 1 channel access, the transmitter may transmit after sensing the channel to be idle during N sensing slots, where N is random number. Additional defer duration is sensed each time the channel is sensed to be busy on one of the N slots. In Type 2A channel access, the transmitter may transmit a transmission immediately after sensing the channel to be idle for at least 25 micro-seconds. In Type 2B channel access, the transmitter may transmit a transmission immediately after sensing the channel to be idle for at least 16 micro-seconds. In Type 2C channel access, the transmitter does not sense the channel before the transmission.

Once a transmitter acquires the channel, it occupies the channel during a COT. A COT may have a maximum duration depending on which LBT type was used to acquire the channel. A transmitter can initiate a COT and share it with another transmitter under some restrictions. For example, LBT type 4 may be used to initially acquire the channel and the gap between different transmissions may be less than a specified gap.

NR supports full deployment in unlicensed bands. Both downlink and uplink may use unlicensed spectrum to transmit data and control signaling. The gNB and the WTRU may perform LBT prior to transmit. A gNB may initiate a COT, which may be referred to as a gNB initiated COT, and share it with WTRUs for uplink transmission. A WTRU may initiate a COT, which may be referred to as, for example, a UE initiated COT or a WTRU initiated COT. The WTRU may then share the COT with the serving gNB. A WTRU determines whether to initiate a COT or share the gNB COT based on an indication from the gNB. For dynamic grant, the DCI scheduling the grant may indicate to the WTRU whether to initiate a COT or share the gNB COT. For configured grant, the WTRU determines whether to initiate a COT or share the gNB COT based on group common DCI transmitted by the gNB to group of WTRUs.

It may be beneficial to initiate a COT and keep it for a relatively long duration to avoid performing multiple LBTs. For example, when a transmitter has multiple transmissions, it may initiate the COT and hold it for multiple slots. Because of these benefits, NR-unlicensed (NR-U) supports multi-slot uplink scheduling, where a single DCI may schedule multiple consecutive PUSCH transmissions. Different transport blocks (TBs) may be transmitted on each slot. The single DCI message scheduling multiple transport blocks may provide the resource allocation parameters for each TB.

Sidelink operation for both Mode 1 and Mode 2 in unlicensed spectrum in FR1 (SL U) is currently being studied. The unlicensed sidelink frequency bands may be 5 GHz and 6 GHz and the Uu operation related to Mode 1 may be limited to licensed spectrum only. The sidelink unlicensed channel access design is to be based on regional regulation requirements with the existing NR-U channel access as a starting point.

To support sidelink in unlicensed bands while keeping the resource allocation under gNB or base station control, such as in resource allocation mode 1, the gNB or base station may need to be aware of the status of the scheduled transmission. With NR V2X deployed in unlicensed spectrum, the WTRU may fail to access the channel to transmit a sidelink transmission. For multi-slot scheduling, one LBT failure impacts multiple scheduled slots and leads to inefficient resource utilization. This problem was not present in NR-U since the multi-slot scheduling was intended to be received by the gNB or base station, and thus the gNB or base station can determine if the transmission is present or not. The gNB or base station may not be able to determine if a V2X WTRU was able to access the channel or not since the sidelink transmission is not intended for the gNB or base station. Waiting for several slots in order to receive the sidelink HARQ-ACK feedbacks for the scheduled transmissions may not be efficient, as those resources may be configured for another V2X WTRU capable of accessing the channel. As such, methods for efficiently scheduling WTRU sidelink transmission and associated uplink feedback in mode 1 in unlicensed spectrum to minimize ambiguity between the gNB or base station, and the WTRU due to LBT uncertainty are desirable.

The terms pre-configuration and configuration may be used interchangeably throughout the embodiments and examples provided herein. As used herein, the term resource may refer to a single resource or may be considered to refer to multiple resources and still be consistent with the embodiments and examples provided herein. Likewise, the term resources may refer to multiple resources or may be considered to refer to a single resource and still be consistent with the embodiments and examples provided herein.

Further, as used herein, a PSCCH/PSSCH transmission may refer to any one of a PSCCH transmission, a PSSCH transmission, or a combination of a PSCCH transmission and a PSSCH transmission, and still be consistent with the embodiments and examples provided herein. Likewise, PSCCH/PSSCH resources may refer to any one of PSCCH resources, PSSCH resources, or a combination of PSCCH resources and PSSCH resources, and still be consistent with the embodiments and examples provided herein. As used herein, resources may include any one of one or more time resources, one or more frequency resources, or a combination of one or more time resources and one or more frequency resources.

Embodiments and examples provided herein include a COT configuration for mode 1 sidelink in an unlicensed band. In some examples, the WTRU may request from the gNB or base station a specific COT configuration along the sidelink unlicensed grant request. For example, the WTRU may request from the gNB or base station a sidelink unlicensed grant within a shared COT. Additionally or alternatively, the WTRU may request a sidelink unlicensed grant to initiate its own COT. In some examples, the WTRU may request a COT duration from the base station. For example, the WTRU may request, from the base station, a 5 ms COT duration for sidelink unlicensed transmission.

The WTRU may include one or more of the following along with the COT configuration request. The WTRU may include a COT duration, where the WTRU may request a specific COT duration to be used for sidelink unlicensed transmission. Also, the WTRU may include a shared COT or COT initiated by the WTRU itself. In an example for shared COT, the WTRU may indicate a preference of particular COT, such as, for example, a different Tx WTRU in proximity that initiated a COT or a base station initiated COT. Further, the WTRU may include a number of shareable slots within a COT. For example, the WTRU may request a COT with a number of slots that can be shared with other sidelink WTRUs.

In some examples, the WTRU may use a MAC control element (CE) to indicate the COT configuration preference to the base station or gNB. For example, the WTRU may use new buffer status report (BSR) format that may indicate the COT configuration preference along with the BSR. In other examples, the WTRU may be configured with a PUCCH resource to indicate a COT configuration preference to the base station. The PUCCH resource may carry a new UCI format that indicates the COT configuration preference.

In some embodiments and examples, a base station (or gNB) may share its COT with a sidelink Tx WTRU. In some examples, a WTRU may be configured to transmit a sidelink unlicensed grant on a shared COT initiated by the gNB in unlicensed band. The WTRU may receive DCI that schedules a sidelink unlicensed grant within a shared COT and may indicate the COT initiator for the configured COT. For example, the DCI may contain a bitfield that indicates three values: a first value that indicates that the COT is initiated by the gNB, a second value that indicates that the COT is initiated by another WTRU, and a third value that indicates that the WTRU is responsible for initiating a COT. The WTRU may be indicated by the gNB which LBT type and/or channel access priority class for the LBT to use when transmitting the sidelink grant within the gNB initiated COT or within another WTRU's initiated COT. For example, a DCI format can carry a bitfield indicating the LBT type and/or channel access priority class.

In some embodiments and examples, a base station (or gNB) may request a Tx WTRU to initiate a COT in a sidelink unlicensed channel. Specifically, in some examples, the WTRU may be indicated by the gNB to initiate a COT in a sidelink unlicensed channel to transmit a scheduled grant on sidelink unlicensed channel. The WTRU may be configured with a new DCI format for scheduling the WTRU to initiate its own COT or existing DCI may be re-used and the interpretation of the bitfields may be different. The WTRU may receive from the gNB one or more of the following to initiate a COT in a sidelink unlicensed channel: resource pool(s), sub-band(s) within the carrier bandwidth, RB set, sub-channels, one or more interlace indices, transmission window, transmission time, and/or a COT configuration.

Received resource pool(s) may be those which the WTRU can attempt to access the channel. For example, the WTRU may receive a resource pool on which the WTRU may attempt to access the channel. The WTRU may select sub-channels for transmission based on the LBT outcome. The DCI scheduling a sidelink grant can indicate a set of resource pools on which to attempt to access the channel and initiate a COT.

Received sub-band(s) within the carrier bandwidth may be those on which the WTRU can attempt to access the channel. The DCI scheduling a sidelink grant may indicate a set of sub-bands on which to attempt to access the channel and initiate a COT.

A received RB set may be that on which the WTRU may attempt to access the channel. In such examples, the WTRU may select the sub-channel to transmit on based on the outcome of channel access procedure (i.e., LBT success or failure). For example, if the WTRU transmits on the sub-channels on which LBT was successful. The DCI scheduling a sidelink grant may indicate a RB set on which to attempt to access the channel and initiate a COT.

Received sub-channels may be those on which the WTRU may attempt to access the channel. In such case, the WTRU may only transmit on the configured sub-channels. If the LBT fails, the WTRU does not transmit the sidelink unlicensed grant. The DCI scheduling a sidelink grant may indicate a set of sub-channels on which to attempt to access the channel and initiate a COT.

Received one or more interlace indices may be those on which the WTRU may attempt to access the channel. The DCI scheduling a sidelink grant may indicate a set of interlaces on which to attempt to access the channel and initiate a COT.

A received transmission window may be that on which the WTRU is allowed to access the channel. In such case, the WTRU may attempt to access the channel at multiple occasion within the transmission time window until the channel is acquired (i.e., LBT success). The DCI scheduling a sidelink grant may indicate a time window to attempt to access the channel and initiate a COT.

If a transmission time is received, in some examples, the WTRU may only be able to transmit on the configured transmission time. If the LBT fails, the WTRU may not transmit the sidelink unlicensed grant.

COT configuration may include maximum COT duration and number of sharable slots. For example, the WTRU may be configured with a maximum COT duration to use for sidelink unlicensed transmission. The maximum COT duration may be defined form the start of the time window to start a COT or alternatively, defined from the time of acquiring the sidelink unlicensed channel, for example, an LBT success. The DCI scheduling the grant may indicate a COT configuration using a bitfield in the DCI.

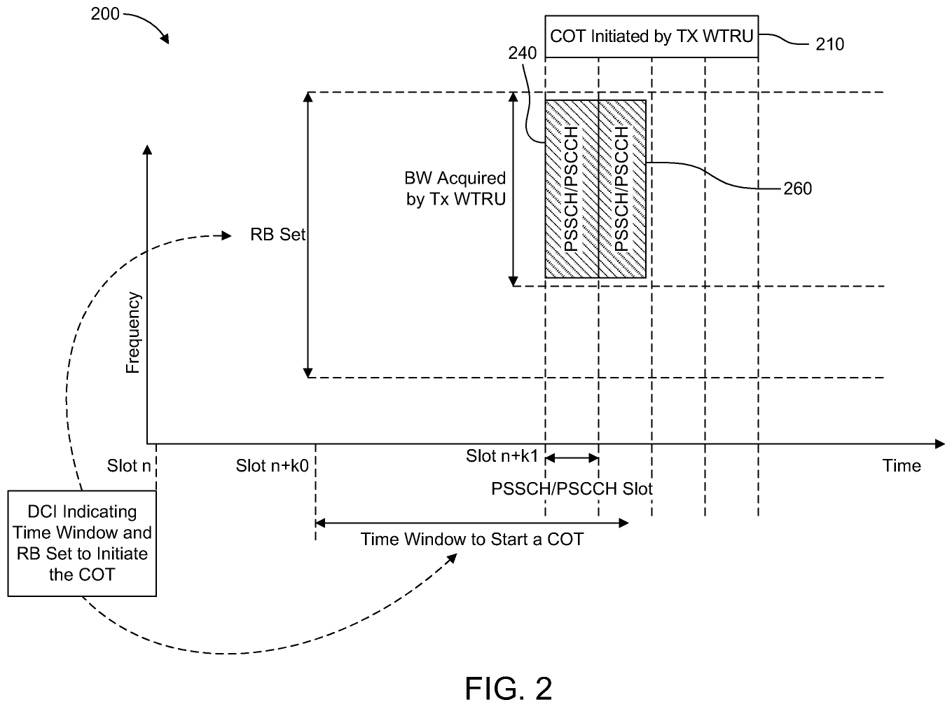

FIG. 2 is a diagram illustrating an example of a WTRU indicated with an RB set and time window to initiate the COT in a sidelink unlicensed channel. In an example shown in diagram 200, the WTRU may be a Tx WTRU. For example, the Tx WTRU may receive in slot #n DCI from the base station indicating a time window to start a COT starting from slot #n+k0, and an RB set to initiate the COT with a certain COT duration. After some LBT attempts, the Tx WTRU may be able to acquire the channel at slot #n+k1 and start transmitting on a bandwidth within the configured RB set. The bandwidth within the configured RB set depends on the LBT outcome.

The Tx WTRU may then initiate a COT with a duration of one slot or multiple slots. For example, the Tx WTRU may initiate a COT 210 of four slots, starting from slot #n+k1. In an example, the slots may be PSSCH/PSCCH slots, and the Tx WTRU may start transmitting PSSCH/PSCCH transmissions in the slots during COT 210. For example, Tx WTRU may transmit PSSCH/PSCCH transmission 240 and PSSCH/PSCCH transmission 260 in COT 210.

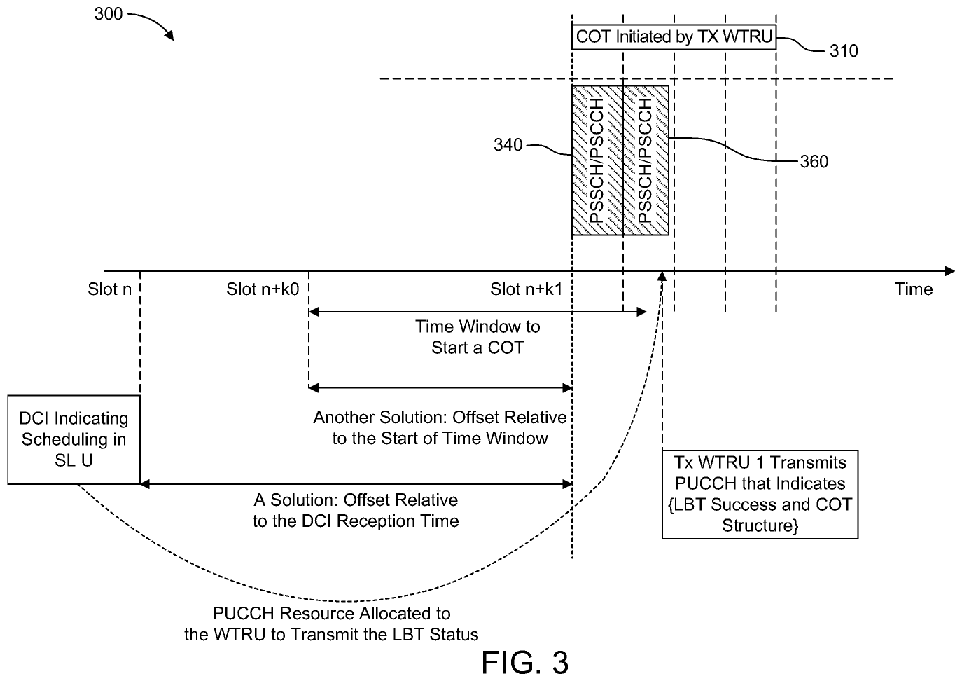

FIG. 3 is a diagram illustrating an example of a WTRU reporting the COT starting time as an offset. In some embodiments and examples, the WTRU may be configured to report to the base station the LBT outcome upon successfully accessing the channel, for example, LBT success, or upon failing to access the channel within the configured time window to start a COT. In an example shown in diagram 300, the WTRU may receive DCI indicating scheduling in SL U. The WTRU may be a Tx WTRU, in examples.

In some examples where the Tx WTRU is reporting LBT success, the Tx WTRU may also report the initiated channel occupancy time characteristics to the base station. To report the LBT outcome and the initiated COT characteristics, the Tx WTRU may be configured to use one or more PUCCH resources, or a new UCI type piggybacked in a PUSCH transmission as shown in an example in FIG. 3.

In an example shown in FIG. 3, the Tx WTRU may initiate a COT with a duration of one slot or multiple slots. For example, the Tx WTRU may initiate a COT 310 of four slots, starting from slot #n+k1. In an example, the slots may be PSSCH/PSCCH slots, and the Tx WTRU may start transmitting PSSCH/PSCCH transmissions in the slots during COT 310. For example, Tx WTRU may transmit PSSCH/PSCCH transmission 340 and PSSCH/PSCCH transmission 360 in COT 310.

Additionally or alternatively, the Tx WTRU may use a MAC Control Element (CE) to report the LBT outcome and the initiated COT characteristics. For example, new BSR can be used by the Tx WTRU to report the initiated COT characteristics. When reporting the Tx WTRU's initiated COT characteristics, the Tx WTRU may indicate to the base station one or more of the following information: COT starting time, intended number of transmission in the COT, reserved sub-channels/interlaces within the initiated COT, COT sharing suggestion to the base station, candidate WTRUs, and whether the Tx WTRU is sharing the COT with another WTRU.

In an example solution where the COT starting time is indicated by the Tx WTRU, the Tx WTRU may be configured to report the slot #n+k1, as shown in FIG. 3. In some example solutions, the WTRU may report the COT starting time explicitly using a UCI codepoint that maps to a pre-configured set of slots offset relative to a reference slot. The reference slot may be the slot where the scheduling DCI is received by the Tx WTRU or the starting of time window to initiate a COT, as shown in FIG. 3. The Tx WTRU may be configured to transmit the PUCCH/UCI carrying the slot offset at a fixed time after the end of the time window to initiate the COT, as shown in FIG. 3. For example, the Tx WTRU may transmit the PUCCH/UCI carrying the slot offset during the COT 310. In an example, the DCI scheduling the sidelink grant may indicate the PUCCH time to report the COT starting time.

In another example solution, the Tx WTRU may report the COT starting time implicitly using the PUCCH/UCI reporting time. For example, the Tx WTRU may be configured to transmit the PUCCH/UCI after a fixed time offset relative to the COT starting time. Such offset may be configured by the base station or fixed in the specification based on the Tx WTRU's capabilities.

In some example solutions where the intended number of transmission(s) in the COT is indicated, depending on the acquired time of the COT, the Tx WTRU may determine how many slots it will use for sidelink transmission. For example, if the Tx WTRU acquires the channel at the end of the configured time window to start a COT, the Tx WTRU may not have enough slots to share with other WTRUs.

In some example solutions where the reserved sub-channels/interlaces within the initiated COT, the Tx WTRU may reserve a set of sub-channels/interlaces within its initiated COT that cannot be shared by other sidelink WTRUs. The Tx WTRU may then report the interlace/sub-channel index reserved.

In some example solutions where the COT sharing suggestion to the base station is indicated, the Tx WTRU may indicate to the base station the set of slots within its COT that can be shared with other sidelink WTRUs. For example, Tx WTRU may indicate the available slots for sharing.

In some example solutions where the candidate WTRUs are indicated, the Tx WTRU may report a set of candidate WTRUs that may share the COT. The Tx WTRU may determine the candidate WTRUs based on the WTRU discovery procedures in sidelink channel(s).

In some example solutions where the Tx WTRU indicates whether the Tx WTRU is sharing the COT with another WTRU, the Tx WTRU may determine that another WTRU needs to use the COT and decide to share its initiated COT and report that information to the base station. For example, the Tx WTRU may decide to share the COT with the receiving WTRU and report that information to the base station. The Tx WTRU may further exclude the resources planned for sharing with receiving WTRU from the available slots when reporting to the base station.

In some example solutions, the Tx WTRU may receive a sharing information/confirmation of its own COT from the base station. The base station validates the COT sharing suggestion from the Tx WTRU or indicates a new COT sharing information regarding the Tx WTRU's initiated COT. In some example solutions, the Tx WTRU may be configured to receive group common DCI that indicates the COT sharing information regarding its initiated COT. The group common DCI may indicate the set of slots within the COT that can be used for sidelink data transmission. For example, the slots may be used for PSSCH transmission. In other examples, the Tx WTRU may receive WTRU-specific DCI that validates the COT sharing suggestion from the Tx WTRU.

In examples provided herein, the Tx WTRU may broadcast its COT structure information in a sidelink unlicensed channel. In some example solutions, the Tx WTRU may be configured to transmit its initiated COT structure to other sidelink unlicensed WTRUs. The Tx WTRU may use a new sidelink control information (SCI) format to transmit the COT structure. Such SCI can be specific to some WTRU, for example, with some destination identity (ID), or group common SCI to group of WTRUs. The Tx WTRU may use a broadcast ID as the destination ID in the SCI to transmit its initiated COT structure. In some example solutions, the Tx WTRU may transmit the COT structure in a sidelink unlicensed channel only after receiving a validation/confirmation of the COT sharing information by the base station. In an example, the Tx WTRU may receive validation/confirmation of the COT sharing information after transmitting COT sharing information to the base station. Such confirmation/validation may be transmitted using group common DCI or WTRU specific DCI, as described above. In other example solutions, the Tx WTRU may transmit the COT structure indication in a sidelink unlicensed channel without waiting to receive a validation/confirmation of the COT sharing information by the base station.

The COT structure indication transmitted by the Tx WTRU may include the set of slots reserved for the Tx WTRU, for example, the initiator of the COT, and the set of slots that can be shared by other Tx WTRUs. For example, a bitmap with size of COT duration and with value equal to one (1) to indicate a sharable slot and value of zero (0) to indicate a reserved slot. The COT duration may be indicated in addition of the bitmap. In other examples, the sidelink WTRUs may be pre-configured with possible COT durations and structures and the WTRU may indicate one of the pre-configured values using a codepoint in a COT structure indication.

The COT structure may also include the priority of sidelink transmission that may be used in the COT. For example, the Tx WTRU may indicate that only a sidelink transmission with priority larger than or equal to an indicated priority that may be used in the shared COT. The COT structure indication may also include the starting time of the COT, the bandwidth part, the sub-band, and/or the RB set and the resource pool that may be used during the COT. The COT structure indication may include the set of reserved frequency resources for the Tx WTRU initiating the COT such as sub-channels and/or set of interlaces.

In some example solutions, the base station may transmit to the sidelink WTRUs the COT structure of an initiated COT by a Tx WTRU. A sidelink WTRU may receive from the base station using a Uu link a COT structure indication, which may contain information described elsewhere herein. The Tx WTRU may receive group common DCI or WTRU specific DCI from the base station that may indicate the COT structure information.

In some embodiments and examples, a base station (or gNB) may share with a Tx WTRU a COT initiated by another Tx WTRU. Specifically, in some examples, the Tx WTRU may be indicated by the base station to transmit on sidelink unlicensed channel using a shared COT initiated by another Tx WTRU. In some example solutions, the Tx WTRU may request a sidelink transmission within a specific COT detected by the Tx WTRU. For example, the Tx WTRU may detect SCI(s) indicating COT structure(s) initiated by other WTRU(s). The Tx WTRU may report to the base station all the detected COT(s) and wait for the base station scheduling. The set of initiated COTs by other WTRUs may be indexed based on the WTRU ID of the WTRU initiating the COT. In an example, a COT index is equal to the WTRU ID that is initiating the COT. The Tx WTRU may indicate a preferred COT when reporting the set of detected COTs to the base station. The Tx WTRU may select a preferred COT based its intended sidelink transmission characteristics. For example, the intended sidelink transmission characteristics may include one or more of sub-band, starting time, transmission duration and transmission duration. For example, the Tx WTRU may select a preferred COT based on the priority indicated for the COT, such as priority described in the COT structure transmission described elsewhere herein. The base station may then schedule the Tx WTRU with sidelink resources belonging to the requested COT. The base station may indicate the COT ID/index in the DCI scheduling sidelink unlicensed grant, which may be referred to as the scheduled COT.

In some example solutions, the Tx WTRU may be requested by the base station to determine if the scheduled COT is already initiated to be able to transmit on that COT. The Tx WTRU may be configured to decode SCI(s) transmitted by WTRUs initiating a COT to verify that the scheduled COT from the base station corresponds to the one of the detected COT(s). The SCI transmitted by a WTRU initiating a COT can carry the COT identification information such as COT ID. The WTRU may use the COT ID and the WTRU ID of the COT initiator to determine which COT is scheduled by the base station. In other example solutions, the WTRU may be configured to validate a COT based on the reference signal received power (RSRP) of the received SCI(s) transmitted by WTRUs initiating a COT. For example, the WTRU may determine that a detected COT is the scheduled COT by the base station if the RSRP of the PSCCH transmission is above a configured threshold.

In some example solutions, the Tx WTRU may be configured to perform a short LBT prior to transmitting on a shared COT. For example, the Tx WTRU may perform a short duration LBT of 16 micro-seconds before transmitting on the shared COT. The Tx WTRU may be indicated, using DCI, with LBT type and the channel access priority class to use for a sidelink transmission. A bitfield in the scheduling DCI may indicate the LBT type and/or the channel access priority. A new DCI format may be introduced to support such indications. Additionally or alternatively, existing bitfields may be re-interpreted differently. For example, HARQ process ID bitfield can be re-used to indicate the LBT type and the channel access priority class.

In some example solutions, the Tx WTRU may be configured to report to the base station whether a COT sharing succeeded or not. For example, the Tx WTRU may report to the base station whether the Tx WTRU was able to detect a COT with the same COT ID of the scheduled COT. The Tx WTRU may be configured with one or more PUCCH resource(s) to indicate the COT sharing status to the base station. In some example solutions, the Tx WTRU may report to the base station whether the short LBT prior to transmission succeeded or not.

Embodiments and examples provided herein include a temporary COT structure. In examples, a COT structure can consist of set of slots and symbols for sidelink transmissions (including slots for sidelink data transmission and slots for sidelink HARQ feedback transmission), set of slots and symbols for uplink transmissions and set of slots and symbols for downlink transmissions. A COT structure may also consist of time domain resources that are reserved for the WTRU initiating the COT and time domain resources that can be shared with other sidelink WTRUs. In examples, the time domain resources may be a set of slots, a set of symbols, or both.

The COT structure can be characterized by a length, which can have a maximum duration equal to the duration of the COT. A temporary COT structure may be defined as a COT structure that has a duration less than the total duration of the COT. In some example solutions, a WTRU may use a temporary COT structure before receiving a COT structure configuration from the base station. The WTRU can be pre-configured with temporary COT structures that can be used after initiating a COT. For example, the WTRU can be preconfigured with temporary COT structure(s) that have different lengths. The WTRU may select one of the pre-configured temporary COT structures based on any one or any combination of the following: the time of LBT success, an expected time to receive a COT structure configuration from the base station (or gNB), the processing time the WTRU needs to process the COT structure configuration from the base station (or gNB), or a resource pool configuration of the sidelink channel.

In an example, the WTRU may select one of the pre-configured temporary COT structures based on the time of LBT success, which may be considered to be, in an example, based on the time of acquiring the channel. The WTRU can be configured with a time window to perform LBT and transmit on a sidelink unlicensed channel. When acquiring the channel, the WTRU may select a temporary COT structure length depending on the remaining time window configured for transmission.

In another example, the WTRU may select one of the pre-configured temporary COT structures based on an expected time to receive a COT structure configuration from the base station (or gNB). For example, the WTRU can select a short temporary COT structure if the WTRU expects to shortly receive a COT structure configuration from the base station. The WTRU can select a temporary COT structure that ends immediately before receiving a COT configuration from the base station.

In an additional example, the WTRU may select one of the pre-configured temporary COT structures based on the processing time the WTRU needs to process the COT structure configuration from the base station (or gNB). For example, the WTRU may need one slot to process DCI transmitted by the base station to configure a COT structure. The WTRU may be expecting DCI to configure a COT structure in slot n. The WTRU can select a temporary COT structure that ends at slot n+1.

In a further example, the WTRU may select one of the pre-configured temporary COT structures based on a resource pool configuration of the sidelink channel. For example, the resource pool configuration may indicate the set of slots for sidelink transmission and slots for uplink transmission. Based on the time of LBT success, the WTRU may determine which slots to use for sidelink transmission within the COT duration.

The temporary COT structure can be configured using system information block (SIB) messages, RRC configuration or fixed in the specifications. In other example solutions, the WTRU may determine a different temporary COT structure than the pre-configured temporary structures.

In some example solutions, the WTRU can keep using temporary COT structure for the entire COT duration if the WTRU does not receive a COT configuration from the gNB. For example, the WTRU may report a preferred COT configuration to the base station after initiating the COT in sidelink unlicensed channel and starts using a temporary COT structure from the pre-configured temporary COT structures. The WTRU may monitor for COT configuration from the base station and may not receive any COT configuration from the base station. In such case, the WTRU may keep using the temporary COT structure for the entire duration of the initiated COT. The duration of the initiated COT can be the maximum COT duration allowed by regulation.

Additionally or alternatively, WTRU can be configured to stop transmitting on sidelink unlicensed channel if the WTRU does not receive a COT structure configuration from the base station. The WTRU may use the sidelink unlicensed channel only before the expected time of receiving COT configuration from the base station.

Embodiments and examples are provided herein of efficient base station (or gNB) scheduling for mode 1 SL U. Examples herein include efficient SL U grant scheduling.

Examples herein include multi-slot scheduling for SL U. In some example solutions, a sidelink Tx WTRU may be configured with multiple TBs to transmit on sidelink unlicensed channel within a COT. The Tx WTRU may be configured with consecutive sidelink TBs or alternatively, non-consecutive sidelink transmissions. For example, the Tx WTRU may receive from the gNB or base station DCI indicating the time domain resource allocation of the multiple sidelink TBs. The time domain resource allocation may indicate the number of sidelink TBs. In some example solutions, the Tx WTRU may be indicated from the base station whether the sidelink TBs are to be transmitted consecutively or not. If the base station indicates a non-consecutive sidelink TBs transmission, the base station may further provide the gap between each sidelink TB transmission. In other example solutions, the Tx WTRU may autonomously decide whether to transmit the scheduled sidelink TBs consecutively or non-consecutively. The Tx WTRU may decide to transmit sidelink TBs consecutively or not within the COT based on one or more of the following: the expected sidelink HARQ feedback from a receiving WTRU, the COT structure, and/or the COT duration.

In examples of the Tx WTRU deciding whether to transmit sidelink TBs consecutively based on the expected sidelink HARQ feedback from receiving WTRU, the Tx WTRU may need the sidelink HARQ feedback to be transmitted by the receiving WTRU immediately after the sidelink TB transmission for latency requirements. In that case, the Tx WTRU may transmit a sidelink TB and wait for sidelink HARQ before transmitting a second sidelink TB. In other example solutions, the Tx WTRU may disable the sidelink HARQ of sidelink TB transmission. In that case, the Tx WTRU may transmit consecutively the scheduled sidelink TBs.

In examples of the Tx WTRU deciding whether to transmit sidelink TBs consecutively based on the COT structure, the WTRU may receive a COT structure indication from the base station along with multiple sidelink TB transmissions. The COT structure may contain transmissions in different direction: sidelink transmissions, UL transmissions or DL transmissions. The Tx WTRU may determine the number of consecutive sidelink TB based on the consecutive slots for sidelink transmissions in the COT structure.

In an example, the Tx WTRU deciding whether to transmit sidelink TBs consecutively based on the COT duration. For example, the Tx WTRU may initiate a COT with a maximum COT duration that does not have enough time for gaps between the different sidelink TB transmissions.

In some examples, a WTRU may be configured with a flexible SL U grant. In some example solutions, a WTRU may be configured with a sidelink grant without association with a HARQ process ID. For example, the WTRU may receive DCI scheduling a sidelink grant with a HARQ process ID value pointing to a reserved HARQ process value. In other example solutions, the sidelink grant may be scheduled by a new DCI format with no HARQ process ID bitfield. The WTRU may be configured to not transmit the sidelink HARQ-ACK feedback of the scheduled sidelink transmission to the gNB or base station in case no HARQ process ID is associated with the scheduled sidelink grant. Instead of reporting the sidelink HARQ-ACK value to the base station, the WTRU may be configured to report a new sidelink scheduling request (SR) in case of a negative ACK (NACK) value received by a receiving WTRU or Tx WTRU failed to access the channel due to LBT failure.

In some example solutions, the WTRU may be configured with a PUCCH resource to transmit such an SR. The DCI scheduling the sidelink grant may configure the WTRU with the PUCCH-SR resource to transmit a request for new sidelink resource if needed. The WTRU may not transmit the PUCCH-SR in case of successful sidelink unlicensed transmission. For example, WTRU may not transmit the PUCCH-SR in case an ACK value is received from the receiving WTRU. The base station may detect the presence/absence of the PUCCH-SR and schedule the WTRU accordingly. The WTRU may be configured with a multi-state PUCCH-SR, for example, PUCCH-SR that carries multiple states, to indicate the number of requested grants. For example, multiple sidelink grants can be scheduled by different DCI and point to the same PUCCH-SR transmission time. The WTRU may use the indicated PUCCH-SR resource to request one or more sidelink grants in case one or more NACK values received by receiving WTRU(s) or the Tx WTRU failed to access the channel due to LBT failure on one or more sidelink grants.

In some example solutions, the WTRU may be configured to use configured a sidelink grant to retransmit an initial transmission that used a dynamic sidelink grant. For example, the WTRU may receive a NACK value from a receiving WTRU and report to the base station the need for a new sidelink grant using PUCCH-SR. The WTRU may receive DCI that activates a configured sidelink grant and use the activated sidelink configured grant to retransmit the sidelink transport block.

In some example solutions, the WTRU may be configured to keep an initiated COT for possible retransmission(s) if needed. The WTRU may receive from the base station an indication in the scheduling DCI to whether or not use an initiated COT for retransmission in case of NACK reception by Rx WTRU. Additionally or alternatively, the WTRU may receive the indication to whether or not use an initiated COT for retransmission in group common DCI. The WTRU may be configured to use the initiated COT for sidelink retransmissions if the COT is maintained by another transmission. For example, the COT is maintained if the Tx WTRU is sharing the COT with another WTRU and the gap between different transmissions is below a configured threshold. The WTRU may determine if its own COT is maintained based on energy detection of sidelink transmission within the sharable slots/sub-channels/interlaces of its own COT or based on decoding of other sidelink transmission on the sharable resources of its own COT. In examples, the decoding may be one or more of SCI decoding, PSSCH decoding, or PSFCH decoding. For example, the WTRU may determine that its COT is maintained if the WTRU receives a PSFCH within its COT from a receiving WTRU carrying the sidelink HARQ-ACK feedback transmission. In another example, the WTRU may determine that its COT is maintained if the WTRU detects an energy above a configured threshold on the slots allocated for shared sidelink transmission. If the WTRU determines that its COT is lost, the WTRU may request additional resources from the base station for retransmission. In an example, the COT may be lost if the COT is not maintained. The WTRU may be configured to report to the base station whether a COT is maintained or not.

Embodiments and example solutions are provided herein of reporting sidelink unlicensed HARQ-ACK status. In some example solutions, a WTRU may be configured to report to a base station (or gNB) the SL HARQ-ACK feedback transmitted on its initiated COT. The WTRU initiating a COT may be configured to monitor all the PSFCH resources associated with PSSCH resources within its COT. In an example, the WTRU initiating a COT may be a Tx WTRU. The Tx WTRU may determine the PSFCH occasions within its COT based on a pre-defined association between one or more PSSCHs and one or more PSFCHs. In such case, another Tx WTRU sharing the COT is not required to transmit the sidelink HARQ-ACK feedback to the base station (or gNB). Instead, the Tx WTRU initiating the COT may be responsible for forwarding the sidelink HARQ-ACK feedbacks to the base station (or gNB). The Tx WTRU initiating the COT may be configured with PUCCH resource(s) to carry all the sidelink HARQ-ACK feedbacks within its COT.

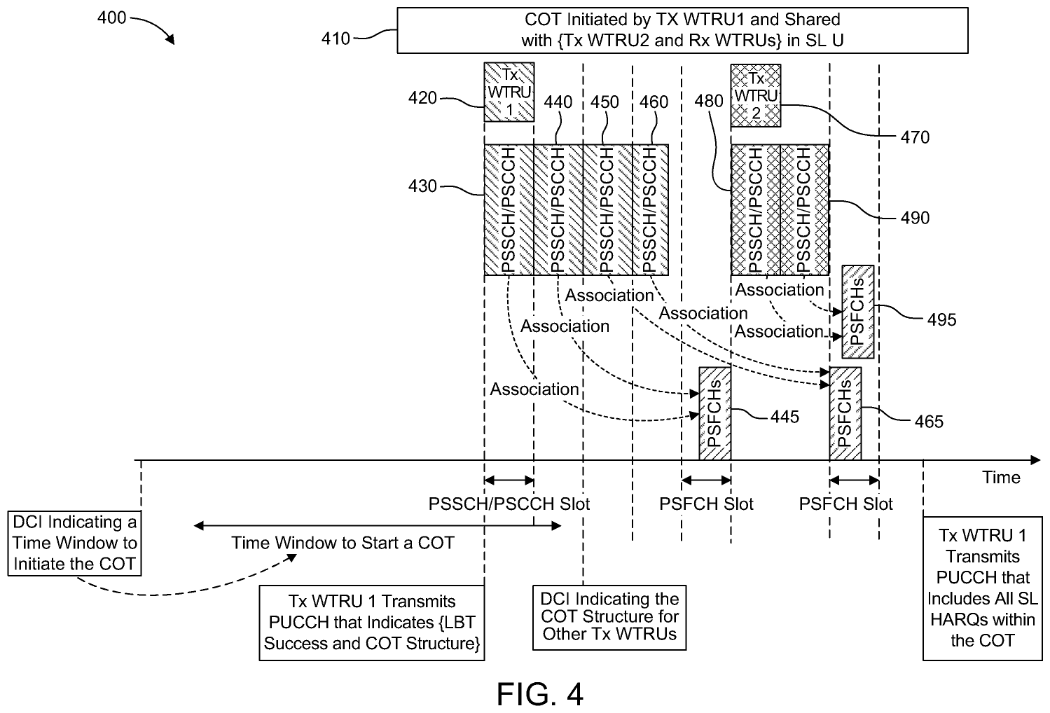

FIG. 4 is a diagram illustrating a Tx WTRU reporting on its initiated COT to a base station. As shown in examples provided in diagram 400, Tx WTRU1 420 may request a sidelink unlicensed grant from the base station (or gNB) and indicate a preference to initiate its own COT. The Tx WTRU1 may receive DCI indicating the RB set/resource pool/transmission window and a maximum COT duration to initiate in sidelink U. The DCI may indicate a time window to initiate the COT. The Tx WTRU1 may perform a successful LBT and initiate a COT in slot n. The Tx WTRU1 may report the initiated COT characteristics to the base station or gNB using a PUCCH transmission or a new UCI type piggybacked in a PUSCH transmission in slot n+offset_1, where offset_1 is configured by the base station or gNB and may be set to 0 based on the WTRU's capability. The Tx WTRU1 may indicate its intended number of transmission(s) in the COT and the interlaces reserved for its own transmission(s) based on the COT starting time and remaining COT duration. The Tx WTRU1 may indicate a COT sharing suggestion to the gNB: the set of slots and interlace to be shared with other WTRUs, such as other Tx WTRUs. Further, the Tx WTRU1 may receive DCI indicating the COT structure for other Tx WTRUs.

The WTRU may receive sharing information/confirmation of its own COT by the base station or gNB using group common DCI in slot n+offset_1+offset_2. Based on the COT sharing information, which may include sharable PSSCH occasions, the WTRU may monitor the PSFCHs of other WTRUs within the WTRU's COT. The WTRU may determine PSFCH occasions to monitor based on the shared PSSCH transmission occasions for other WTRUs. In examples illustrated in FIG. 4, Tx WTRU2 470 may be sharing the COT. The Tx WTRU1 420 may report to the base station or gNB the sidelink HARQ feedback corresponding to the transmission of Tx WTRU1 420 as well as sidelink HARQ feedback transmitted by other Tx WTRUs, such as Tx WTRU2 470, within the shared the COT using PUCCH/PUSCH resource(s).

In an example shown in FIG. 4, Tx WTRU1 420 may transmit one or more of PSSCH/PSCCH transmission 430, PSSCH/PSCCH transmission 440, PSSCH/PSCCH transmission 450, or PSSCH/PSCCH transmission 460. The PSSCH/PSCCH transmission use PSSCH/PSCCH resources. In an example, PSSCH/PSCCH transmission 430 and PSSCH/PSCCH transmission 440 may be associated with one or more PSFCH transmissions 445. Accordingly, Tx WTRU1 420 may transmit PSSCH/PSCCH transmission 430 and expect to receive sidelink HARQ feedback regarding transmitted PSSCH/PSCCH transmission 430 in a PSFCH transmission in the PSFCH transmissions 445. Similarly, Tx WTRU1 420 may transmit PSSCH/PSCCH transmission 440 and expect to receive sidelink HARQ feedback regarding transmitted PSSCH/PSCCH transmission 440 in a PSFCH transmission in the PSFCH transmissions 445. Transmitter WTRU1 420 may then receive this sidelink HARQ feedback. Further, PSSCH/PSCCH transmission 450 and PSSCH/PSCCH transmission 460 may be associated with one or more PSFCH transmissions 465. Accordingly, Tx WTRU1 420 may transmit PSSCH/PSCCH transmission 450 and expect to receive sidelink HARQ feedback regarding transmitted PSSCH/PSCCH transmission 450 in a PSFCH transmission in the PSFCH transmissions 465. Transmitter WTRU1 420 may then receive this sidelink feedback. Similarly, Tx WTRU1 420 may transmit PSSCH/PSCCH transmission 460 and expect to receive sidelink HARQ feedback regarding transmitted PSSCH/PSCCH transmission 460 in a PSFCH transmission in the PSFCH transmissions 465. Transmitter WTRU1 420 may then receive this feedback.

Also, in an example shown in FIG. 4, Tx WTRU2 470 may transmit one or more of PSSCH/PSCCH transmission 480 or PSSCH/PSCCH transmission 490. In addition, PSSCH/PSCCH transmission 480 and PSSCH/PSCCH transmission 490 may be associated with one or more PSFCH transmissions 495. Accordingly, Tx WTRU2 470 may transmit PSSCH/PSCCH transmission 480 and expect to receive, and receive, sidelink HARQ feedback regarding transmitted PSSCH/PSCCH transmission 480 in a PSFCH transmission in the PSFCH transmissions 495. Similarly, Tx WTRU2 470 may transmit PSSCH/PSCCH transmission 490 and expect to receive sidelink HARQ feedback regarding transmitted PSSCH/PSCCH transmission 490 in a PSFCH transmission in the PSFCH transmissions 495. Transmitter WTRU2 470 may receive this feedback in the PSFCH transmission.

Further, as described above, in an example shown in FIG. 4, Tx WTRU1 420 may share its COT with Tx WTRU2 470. Accordingly, Tx WTRU1 420 may determine PSFCH occasions to monitor based on the shared PSSCH transmission occasions for WTRU2 470. For example, Tx WTRU1 420 may determine to monitor PSFCH occasions associated with PSSCH/PSCCH transmission 480 or PSSCH/PSCCH transmission 490 of Tx WTRU2 470. As a result, Tx WTRU1 420 may receive sidelink HARQ feedback regarding transmitted PSSCH/PSCCH transmission 480 in a PSFCH transmission in the PSFCH transmissions 495. Additionally or alternatively, WTRU1 420 may receive sidelink HARQ feedback regarding transmitted PSSCH/PSCCH transmission 490 in a PSFCH transmission in the PSFCH transmissions 495. Transmitter WTRU1 420 may then report the received sidelink HARQ feedback, regarding the transmission of Tx WTRU2 470, to the base station. Further, Tx WTRU1 420 may use PUCCH/PUSCH resource(s) to report this sidelink HARQ feedback.

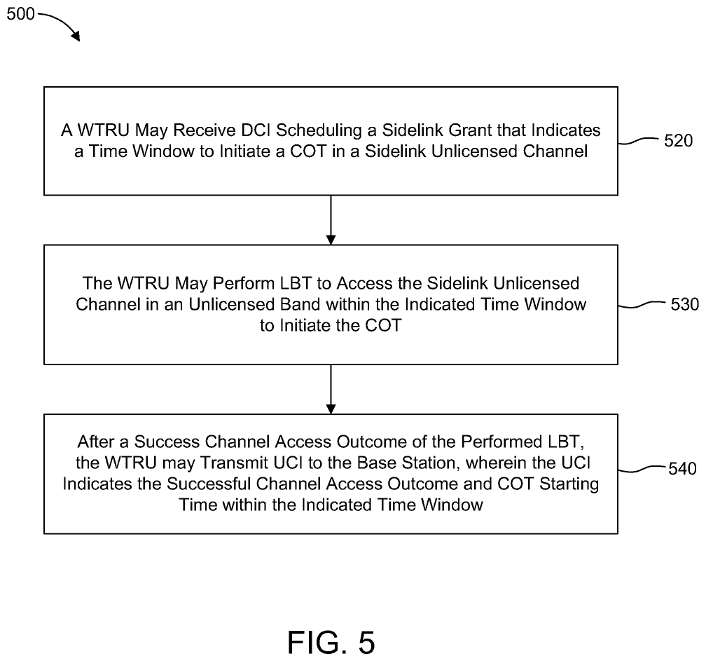

FIG. 5 is a flowchart diagram illustrating an example of a WTRU reporting on its initiated COT to a base station. In an example shown in flowchart diagram 500, a WTRU may receive DCI, from a base station, scheduling a sidelink grant that indicates a time window to initiate a COT 520. In an example, the COT may be initiated in a sidelink unlicensed channel. Further, the WTRU may perform LBT to access the sidelink unlicensed channel, in an unlicensed band, within the indicated time window to initiate the COT 530.

Moreover, the WTRU may initiate the COT, in an example. The COT may be initiated by the WTRU at the COT starting time and the COT may last for a COT duration. Further, the WTRU may occupy the sidelink unlicensed channel during the COT.

After a successful channel access outcome of the performed LBT, the WTRU may provide information to the base station about the initiated COT. In an example, the WTRU may transmit UCI to the base station 540 about the COT. The UCI may indicate or may report the successful channel access outcome of the performed LBT. Further, the UCI may indicate or may report a COT starting time within the indicated time window to initiate the COT. The UCI may be a new UCI type or a modified UCI type. In an example, the WTRU may include characteristics of the initiated COT in the information provided to the base station. In a further example, the WTRU may provide the information about the initiated COT to the base station using a PUCCH transmission.

In an example, the UCI may indicate or may report an intended number of transmissions by the WTRU in the COT. In another example, the UCI may indicate or may report one or more reserved sub-channels within the COT. In a further example, the UCI may indicate or may report one or more reserved interlaces within the COT. In an additional example, the UCI may indicate or may report one or more reserved slots within the COT.

In a further example, the WTRU reporting on its initiated COT may be a first WTRU. Further, the first WTRU may determine whether to share its COT with other WTRUs. The other WTRUs may be second WTRUs. The first WTRU may make the determination based on a buffer status and the COT starting time. In an example, the first WTRU may determine to share its COT with the second WTRUs. The first WTRU may then also provide a COT sharing suggestion to the base station. The first WTRU may then receive, from the base station, a COT sharing confirmation validating the COT sharing suggestion provided by the first WTRU. The COT sharing confirmation may be received using a group common DCI, in an example.

Further, the first WTRU may monitor one or more PSFCH transmissions of one or more of the second WTRUs sharing the COT initiated by the first WTRU. Additionally, the first WTRU may report, to the base station, sidelink HARQ ACK feedback from the one or more PSFCH transmissions of the one or more of the second WTRUs sharing the COT initiated by the first WTRU. In a further example, the first WTRU may be a Tx WTRU. In another example, the second WTRUs may be other Tx WTRUs. In an alternative example or an additional example, the second WTRUs may be or may include Rx WTRUs.

In some example solutions, the WTRU may be configured to use a HARQ-ACK codebook to report the sidelink HARQ-ACK feedbacks transmitted within its initiated COT. Such a HARQ-ACK codebook may be configured with a fixed size and may consist of the sidelink HARQ-ACK feedback transmitted within the same COT. The WTRU may determine the HARQ-ACK codebook size based on the number of PSFCH slots within the COT. The WTRU may determine the HARQ-ACK codebook size based on the COT structure indicated by the base station (or gNB). For example, the WTRU after initiating the COT and reporting the LBT status to the gNB, may receive a COT structure from the gNB with a set of slots sharable with other WTRUs. Based on the number of slots for PSSCH transmissions, the WTRU may determine the HARQ-ACK codebook size. In an example, HARQ-ACK codebook size may be equal to the number of PSSCH slots within a COT.

Additionally or alternatively, the WTRU may receive from the base station (or gNB) the HARQ-ACK codebook size using DCI. Such a HARQ-ACK codebook may support 3-states HARQ-ACK values. In examples, a first state indicates a NACK value, a second state indicates ACK value, and a third state indicates the sidelink HARQ-ACK feedback could not be received/detected/correctly decoded. The WTRU may be configured to order the sidelink HARQ-ACK feedbacks in increasing order of the reception time. For example, the first value of the HARQ-ACK codebook may correspond to the first PSFCH slot within the COT and the last value of the HARQ-ACK codebook may correspond to the last PSFCH slot within the COT. In other examples, the WTRU may put first the sidelink HARQ-ACK values of its own transmission and append the HARQ ACK values of the other sidelink transmissions.

In some example solutions, the WTRU may be configured to determine the presence of sidelink HARQ-ACK within its COT based on SCI decoding. For example, the WTRU may detect the SCI of the Tx WTRUs within its COT and determine whether the sidelink HARQ-ACK is enabled or not for each transmission. In other examples, the WTRU may determine the presence of sidelink HARQ-ACK within its COT based on the energy detection of the PSFCH resources. For example, the WTRU may monitor a PSFCH resource corresponding to the PSSCHs transmissions within its COT and determine whether the detected energy is above or below a configured threshold. Upon detecting that PSFCH is not transmitted, the WTRU may report, to the base station or gNB, the third state of HARQ-ACK. For example, the WTRU may indicate the sidelink HARQ-ACK feedback could not be received/detected/correctly decoded.

In some example solutions, the WTRU may be configured to report/forward to the base station (gNB) the SL HARQ-ACK feedback of a sub-group of SL HARQ feedback transmitted within its initiated COT. The WTRU may be configured to determine the sub-group of SL HARQ-ACK feedback based on any one or any combination of the following: the ID(s) of the WTRU(s) transmitting sidelink HARQ-ACK feedback on the WTRU's initiated COT, the priority associated with sidelink data corresponding to the sidelink HARQ-ACK feedback, or the QoS associated with sidelink data corresponding to the sidelink HARQ-ACK feedback.

In an example, the WTRU may be configured to determine the sub-group of SL HARQ-ACK feedback based on the ID(s) of the WTRU(s) transmitting sidelink HARQ-ACK feedback on the WTRU's initiated COT. For example, the WTRU may report/forward the sidelink HARQ-ACK feedbacks of only a group of WTRUs. The WTRU may be configured with WTRU IDs for which the sidelink HARQ-ACK feedback can be forwarded to the base station (or gNB).

In another example, the WTRU may be configured to determine the sub-group of SL HARQ-ACK feedback based on the priority associated with sidelink data corresponding to the sidelink HARQ-ACK feedback. The WTRU can be configured to report/forward a sidelink HARQ-ACK feedback to the base station (or gNB) if the priority of sidelink data transmission associated with SL HARQ-ACK feedback is above a configured priority. In an example, the priority of the sidelink data transmission may be a higher priority.

In a further example, the WTRU may be configured to determine the sub-group of SL HARQ-ACK feedback based on the QoS associated with sidelink data corresponding to the sidelink HARQ-ACK feedback. The WTRU can be configured to report/forward a sidelink HARQ-ACK feedback to the gNB if the QoS of sidelink data transmission associated with SL HARQ-ACK feedback is corresponding to one or more pre-configured QoS values.

In some example solutions, the WTRU may be configured to report/forward to the base station (or gNB) the SL HARQ-ACK feedback of only the intended Rx WTRUs of the WTRU. For example, a Tx WTRU initiated a COT and transmits to multiple Rx WTRUs and shares the COT with other Tx WTRUs. The Tx WTRU may report the SL HARQ-ACK to the base station (or gNB) of only its intended Rx WTRU. The intended Rx WTRU here may mean the Rx WTRUs receiving sidelink data from the Tx WTRU initiating the COT.

In some example solutions, the WTRU may be configured to report SL HARQ-ACK feedback transmitted within its COT by other WTRUs using separate HARQ-ACK codebook(s). The size of the HARQ-ACK codebook can be determined based on the number of PSFCH occasions within the COT initiated by the WTRU. Additionally or alternatively, the size can be indicated to the WTRU by the base station (or gNB). For example, DCI configuring the COT structure may indicate the size of the HARQ-ACK codebook for SL HARQ-ACK of other WTRUs. The WTRU can determine the size of the HARQ codebook using the identified sub-group described above.

In some example solutions, the WTRU may be configured to report to the gNB a delayed sidelink HARQ-ACK value upon failing to share its COT with an Rx WTRU to transmit sidelink HARQ-ACK feedback. For example, the Tx WTRU may be configured from the base station or gNB with a single slot or multiple slots for sidelink unlicensed transmissions.

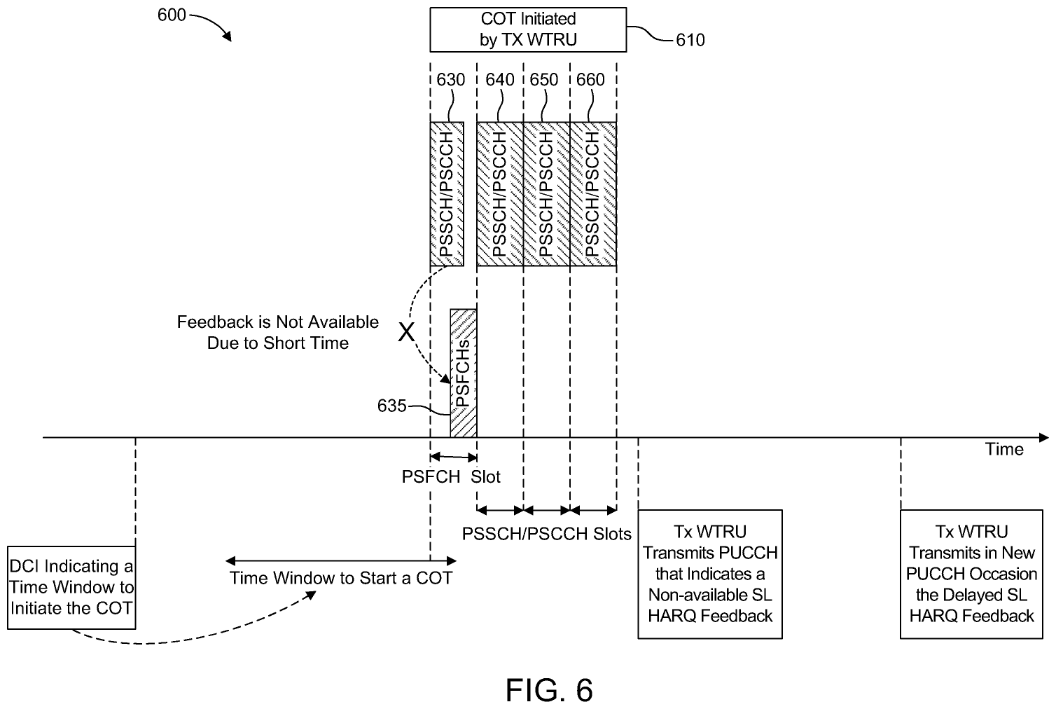

FIG. 6 is a diagram illustrating a Tx WTRU reporting a delayed sidelink HARQ-ACK to a base station. The Tx WTRU may transmit on the scheduled grant(s) upon successful LBT as shown in an example in diagram 600. For example, a Tx WTRU may receive a time window to initiate a COT. Further, the Tx WTRU may transmit one or more of PSSCH/PSCCH transmission 630, PSSCH/PSCCH transmission 640, PSSCH/PSCCH transmission 650 or PSSCH/PSCCH transmission 660 in a COT initiated by the Tx WTRU 610.

Based on its intended number of transmission(s), for example, buffer status, and the starting of the transmission (COT starting time), the Tx WTRU may determine whether it will share the COT 610 or not with Rx WTRU. If the Tx WTRU is not sharing its COT with Rx WTRU in order to transmit sidelink HARQ-ACK feedback, the WTRU may report a delayed sidelink HARQ-ACK feedback value to the base station (or gNB).

The WTRU may determine whether to share its COT with Rx WTRU based on the available slots for PSFCH within its own COT. For example, the WTRU may be configured with a resource pool to initiate a COT. The resource pool may have a slot configuration that indicates which slot is for PSSCH transmission and which transmission is for PSFCH transmission. Upon successfully initiating the COT, the WTRU may determine that no PSFCH slot is available for PSFCH transmission within its COT duration. The WTRU then does not share its COT with Rx WTRU to transmit sidelink HARQ-ACK feedback.

Further, in an example, the Tx WTRU may determine that sidelink feedback from an Rx WTRU is not available. In an example, the feedback may not be available due to a short amount of time between the PSSCH/PSCCH transmission and an associated PSFCH transmission. For example, Tx WTRU may transmit PSSCH/PSCCH transmission 630. However, a PSFCH transmission received in PFSCH transmissions 635 would not include feedback from PSSCH/PSCCH transmission 630, since there would not be enough time for the Rx WTRU to receive PSSCH/PSCCH transmission 630 and then generate corresponding feedback. As a result, the Tx WTRU may transmit information on a PUCCH transmission that indicates non-available sidelink feedback.

In some example solutions, the Tx WTRU may be configured to determine whether to share its COT with Rx WTRU for sidelink HARQ-ACK transmission or not based on the sidelink TB priority and/or the packet delay budget (PDB) of the sidelink transmission. For example, the Tx WTRU may prioritize the sidelink HARQ-ACK feedback over new sidelink TB transmissions in then initiated COT. The Tx WTRU may indicate to the Rx WTRU such prioritization using SCI signaling. For example, a bitfield in the SCI may indicate to Rx WTRU whether to use the current COT or different COT for sidelink HARQ-ACK transmission. In case the sidelink HARQ-ACK is prioritized, the Rx WTRU may use one of the slots within the COT to transmit the HARQ-ACK feedback. The Rx WTRU may determine the slot to send the feedback based on pre-configured slot offset between PSSCH and PSFCH. Additionally or alternatively, the Tx WTRU may indicate to Rx WTRU the slot to send the feedback. In some examples, the Rx WTRU may report HARQ-ACK of a group of HARQ processes to the Tx WTRU in case of LBT failure and/or not being able to share the COT.

In some example solutions, the Tx WTRU may be configured to report an estimated time for sidelink HARQ transmission when reporting delayed sidelink HARQ-ACK feedback. The WTRU may be pre-configured with multiple possible estimated values and indicate one of the pre-configured values. The WTRU may determine an estimated time for sidelink HARQ transmission based on the available sidelink unlicensed grants and the expected future COT sharing by the WTRU in the subsequent slots. For example, the WTRU is expecting to initiate a COT to transmit on the assigned sidelink unlicensed grant. The WTRU may then report an estimated time based on estimated COT structure of the next sidelink unlicensed grant.

In some example solutions, the Tx WTRU may be configured to monitor for a new PUCCH resource assignment after reporting to the base station or gNB a delayed sidelink HARQ-ACK value. For example, upon reporting a delayed sidelink HARQ feedback to the base station or gNB, the Tx WTRU may receive DCI that indicates a new PUCCH resource to acknowledge the sidelink HARQ-ACK transmission in later occasion. The Tx WTRU may then transmit the delayed sidelink HARQ feedback in the new PUCCH occasion. In other examples, the Tx WTRU may receive a one-shot HARQ-ACK triggers to report the HARQ feedback for group or all the sidelink unlicensed grants.

In some example solutions, the Tx WTRU may be configured to report to the base station or gNB a delayed sidelink HARQ-ACK value upon failing to receive sidelink HARQ-ACK feedback from the Rx WTRU. For example, the Tx WTRU may not be sharing the COT with the Rx WTRU, but the Tx WTRU may be aware that the Rx WTRU is configured with a subsequent grant on which the sidelink HARQ-ACK can be transmitted. In such case, the Tx WTRU may report a delayed sidelink HARQ-ACK feedback to the base station or gNB.

In some example solutions, the WTRU may be configured to flush the HARQ-ACK buffer corresponding to sidelink unlicensed transmission when the PDB is expired. In that case, the WTRU may indicate an ACK value to the base station or gNB upon the flushing the HARQ-ACK buffer.

In some example solutions, the WTRU may be configured to group a set of sidelink HARQ-ACK feedbacks in the same HARQ codebook to be reported simultaneously to the base station or gNB. In some example solutions, the WTRU may be configured to group the sidelink HARQ-ACK based on the WTRU destination ID. For example, the WTRU may group the sidelink HARQ-ACKs of the same WTRU destination ID in the same group. In other examples, the WTRU may group the sidelink HARQ-ACKs of a range of WTRU destination IDs in the same group. In other example solutions, the WTRU may be configured with an association between a HARQ codebook/group and a set of sidelink HARQ-ACK processes. The base station or gNB may request the transmission of one or more HARQ codebooks/groups using DCI. In other examples, the base station or gNB may configure the WTRU with a HARQ grouping based on BSR reporting and priority of the reported BSR. For example, some WTRU destination IDs may have higher priority. When reporting the sidelink HARQ group, the WTRU may indicate the HARQ group ID along the HARQ group feedback.

In some example solutions, when reporting to the base station or gNB the HARQ groups, the WTRU may be configured to prioritize among different sidelink HARQ groups. For example, the WTRU may prioritize based on one or more WTRUs' destination IDs of a HARQ group.

In some example solutions, an Rx WTRU may prioritize among multiple PSFCH transmissions to different Tx WTRUs based on whether the COT is initiated by Tx WTRU and it is being shared with the Rx WTRU or not. For example, an Rx WTRU may receive two PSSCH transmissions from two different WTRUs, such as, for example, Tx WTRU1 and Tx WTRU2, with the Tx WTRU1 sharing its COT with Rx WTRU and Tx WTRU2 not sharing the COT and indicating to initiate a different COT for sidelink HARQ transmission. The Rx WTRU may prioritize the PSFCH transmission to Tx WTRU1. In some example solutions, the priority of the sidelink HARQ feedback may be increased after each missed PSFCH transmission.

Examples provided herein include additional HARQ-ACK feedback occasions. An Rx WTRU with HARQ feedback to transmit may initiate a COT to transmit the feedback. For example, the Rx WTRU may have one or more resources in which it may transmit feedback to the Tx WTRU. In an example, the one or more resources may be one or more periodic resources. The Rx WTRU may transmit HARQ feedback to at least one Tx WTRU if it is able to initiate a COT prior to a HARQ-ACK feedback resource. The Rx WTRU may have one or more, or a set of, HARQ-ACK feedback resources associated with each transmission from one or more Tx WTRUs.

The Rx WTRU may attempt to initiate a COT prior to at least one HARQ-ACK feedback resource if a HARQ-ACK feedback is valid. The Rx WTRU may determine whether a HARQ-ACK feedback is valid based on at least one of: the PDB of a sidelink TB, an indication from the Tx WTRU, a maximum number of feedback attempts, configuration information, such as from the base station or from the gNB, or the priority of the feedback.

The Rx WTRU may monitor the channel for an indication from a Tx WTRU that the Tx WTRU has initiated a COT for the Rx WTRU transmission of HARQ-ACK feedback. For example, if the Rx WTRU fails to initiate a COT for the transmission of a HARQ-ACK feedback, the Rx WTRU may monitor for an indication that the Tx WTRU has initiated a COT in which the Rx WTRU may report HARQ-ACK feedback. The Rx WTRU may determine what HARQ-ACK feedback to report as a function of at least one of: an indication from the Tx WTRU, the identity of the WTRU that initiated the COT, the timing of the COT, the priority of the feedback, the timing of the feedback resources within the COT, and/or the validity of the HARQ-ACK feedback.

A Tx WTRU may be triggered to initiate a COT for the purpose of sharing it with one or more Rx WTRU(s) for the transmission of HARQ-ACK feedback. For example, a Tx WTRU may be triggered to initiate a COT if it determines that an Rx WTRU has failed to initiate a COT for the transmission of a HARQ-ACK feedback. In other examples, a Tx WTRU may be triggered to initiate a COT for the purpose of sharing it with one or more Rx WTRU(s) by signaling from the base station or gNB.

A Tx WTRU initiating a COT for the purpose of sharing with one or more Rx WTRU(s) may indicate that the COT is available for transmission of HARQ-ACK feedback. The indication may be included in one or more of a PSSCH transmission, SCI or a PUSCH transmission. The indication may be implicitly transmitted via an SL-reference signal (RS) or SL-synchronization signal (SS)/SS block (SSB) transmission.

A Tx WTRU may indicate to the Rx WTRU(s) that may they share the COT for the transmission of HARQ-ACK feedback. A Tx WTRU may indicate the set of HARQ Processes for which it expects HARQ-ACK feedback. The set of HARQ Processes may be indicated as a set.

Embodiments and examples are provided herein of measurements and reports of SL U assistance information. In some example solutions, the WTRU may be configured to report assisting information to a base station (or gNB) to help differentiating between the case of a congested resource pool due to one or more other sidelink transmissions, or the case of another unlicensed transmission(s) such as WiFi. The WTRU may be configured with a set of time windows. Each window may correspond potentially to a COT initiated by the WTRU itself or by another WTRU. In some example solutions, for each set of time windows/COTs, the WTRU may be configured to measure the ratio of sub-channels where the received signal strength indicator (RSSI) or RSRP exceeds a preconfigured threshold. The WTRU may then report a set of ratios corresponding to each COT/time window to the base station (or gNB). In other example solutions, the WTRU may be configured to measure the ratio of sub-channels where the RSSI or RSSP exceeds a preconfigured threshold outside the COT and inside the COT, and may report, for each COT, the difference between the ratio measured outside the COT and the ratio measured inside the COT. In other example solutions, for each set of time windows/COTs, the WTRU may be configured to measure the number of sub-channels used by the WTRU. In other example solutions, the WTRU may be configured to report the measurements described above only if one or more of the following conditions are satisfied: a number of LBT failure(s) for the WTRU is above a configured threshold for a pre-configured time window, and/or a number of LBT success(es) for the WTRU is below a configured threshold for a pre-configured time window.

In some example solutions, the WTRU may be configured to perform some measurements to differentiate between half duplex and channel access failure. The WTRU may be configured to then report to the base station or gNB the ratio of the number of half duplex issue occurrence over the number of channel access failures, over a configured time window. In an example, the number of channel access failures may be or may include the number of LBT failures. The WTRU may trigger such reporting if the ratio is above or below a configured threshold. The WTRU may use one or more of RRC signaling, a MAC CE, or UCI to transmit the ratio. In some example solutions, the WTRU may be configured to use different bandwidth part (BWP)/sub-band/RB set/resource pool if the measure ratio is above or below a configured threshold. The WTRU may then indicate to other WTRUs the BWP/sub-band/RB set/resource pool change. For example, an Rx WTRU may indicate to the Tx WTRU the change of BWP/sub-band/RB set/resource pool.

The methods and procedures in the embodiments and examples described herein may be performed by one or more of a processor, integrated circuit, network node, relay node, base station, AP, STA, vehicle or drone. Further, one of ordinary skill in the art will appreciate that the embodiments and examples described herein include means for performing or means configured to perform the methods and procedures described herein

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections), non-transitory storage media and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method performed by a first wireless transmit/receive unit (WTRU), the method comprising:
receiving downlink control information (DCI) from a base station scheduling a sidelink grant, wherein the sidelink grant indicates a time window to initiate a channel occupancy time (COT);
performing listen-before-talk (LBT) to access a sidelink unlicensed channel in an unlicensed band within the indicated time window to initiate the COT; and
after a successful channel access outcome of the performed LBT, transmitting uplink control information (UCI) to the base station, wherein the UCI indicates the successful channel access outcome and a COT starting time within the indicated time window to initiate the COT.

2. The method of claim 1, wherein the UCI further indicates an intended number of transmissions by the first WTRU in the COT.

3. The method of claim 1, wherein the UCI further indicates one or more reserved sub-channels within the COT.

4. The method of claim 1, wherein the UCI further indicates one or more reserved interlaces within the COT.

5. The method of claim 1, further comprising:
determining, based on a buffer status and the COT starting time, whether the first WTRU will share the COT; and
providing, based on a determination to share the COT, a COT sharing suggestion to the base station.

6. The method of claim 5, further comprising:
receiving a COT sharing confirmation validating the COT sharing suggestion provided by the first WTRU.

7. The method of claim 1, further comprising:
initiating the COT, wherein the COT is initiated at the COT starting time and lasts for a COT duration, and wherein the first WTRU occupies the sidelink unlicensed channel during the COT.

8. The method of claim 7, further comprising:
monitoring one or more physical sidelink feedback channel (PSFCH) transmissions of one or more second WTRUs sharing the COT initiated by the first WTRU.

9. The method of claim 8, further comprising:
reporting, to the base station, sidelink hybrid automatic repeat request (HARQ) acknowledgement (ACK) feedback from the one or more PSFCH transmissions of the one or more second WTRUs sharing the COT initiated by the first WTRU.

10. The method of claim 1, wherein the first WTRU is a transmitter (Tx) WTRU.

11. A first wireless transmit/receive unit (WTRU) comprising:
a transceiver; and
a processor, operatively coupled to the transceiver; wherein:
the transceiver is configured to receive downlink control information (DCI) from a base station scheduling a sidelink grant, wherein the sidelink grant indicates a time window to initiate a channel occupancy time (COT);
the transceiver and the processor are configured to perform listen-before-talk (LBT) to access a sidelink unlicensed channel in an unlicensed band within the indicated time window to initiate the COT; and
the transceiver and the processor are configured to transmit, after a successful channel access outcome of the performed LBT, uplink control information (UCI) to the base station, wherein the UCI indicates the successful channel access outcome and a COT starting time within the indicated time window to initiate the COT.

12. The first WTRU of claim 11, wherein the UCI further indicates an intended number of transmissions by the first WTRU in the COT.

13. The first WTRU of claim 11, wherein the UCI further indicates one or more reserved sub-channels within the COT.

14. The first WTRU of claim 11, wherein the UCI further indicates one or more reserved interlaces within the COT.

15. The first WTRU of claim 11, wherein the processor is further configured to determine, based on a buffer status and the COT starting time, whether the first WTRU will share the COT; and wherein the transceiver and the processor are further configured to provide, based on a determination to share the COT, a COT sharing suggestion to the base station.

16. The first WTRU of claim 15, wherein the transceiver is further configured to receive a COT sharing confirmation validating the COT sharing suggestion provided by the first WTRU.

17. The first WTRU of claim 11, wherein the transceiver and the processor are further configured to initiate the COT, wherein the COT is initiated at the COT starting time and lasts for a COT duration, and wherein the first WTRU occupies the sidelink unlicensed channel during the COT.

18. The first WTRU of claim 17, wherein the transceiver and the processor are further configured to monitor one or more physical sidelink feedback channel (PSFCH) transmissions of one or more second WTRUs sharing the COT initiated by the first WTRU.

19. The first WTRU of claim 18, wherein the transceiver and the processor are configured to report, to the base station, sidelink hybrid automatic repeat request (HARQ) acknowledgement (ACK) feedback from the one or more PSFCH transmissions of the one or more second WTRUs sharing the COT initiated by the first WTRU.

20. The first WTRU of claim 11, wherein the first WTRU is a transmitter (Tx) WTRU.
